(19) United States
(12) Patent Application Publication
(10) Pub. No.: US 2016/0369845 A1
(43) Pub. Date: Dec. 22, 2016

(54) SLIDING CONSTANT VELOCITY JOINT

(71) Applicant: JTEKT CORPORATION, Osaka-shi (JP)

(72) Inventor: Keishi KOBATA, Anjo-shi (JP)

(73) Assignee: JTEKT CORPORATION, Osaka-shi (JP)

(21) Appl. No.: 15/180,609

(22) Filed: Jun. 13, 2016

(30) Foreign Application Priority Data
Jun. 18, 2015 (JP) 2015-122961

(51) Int. Cl. F16C 29/06; F16C 33/58; F16C 33/34

(52) U.S. Cl. CPC F16C 29/0602; F16C 33/34; F16C 33/58

(57) ABSTRACT

A sliding constant velocity joint 1 includes: an outer ring serving as an outer member; a tripod member serving as an inner member; an intermediate member that is formed by a pair of divided members placed so as to be separated from each other with a head of a tripod shaft portion interposed therebetween; a plurality of rolling elements that roll on first and second raceway surfaces of the outer ring; and a cage holding the plurality of rolling elements. When the rolling elements are pressed by the pair of divided members and the bodies of the rolling elements are brought into contact with the pair of raceway surfaces, there is predetermined clearance between an outer peripheral surface of a needle-like projection of each rolling element and outer side surfaces in first and second grooves.

### INCORPORATION BY REFERENCE

The disclosure of Japanese Patent Application No. 2015-122961 filed on Jun. 18, 2015 including the specification, drawings and abstract, is incorporated herein by reference in its entirety.

### BACKGROUND OF THE INVENTION

1. Field of the Invention

The present invention relates to sliding constant velocity (CV) joints.

2. Description of the Related Art

An example of conventional CV joints is a sliding CV joint including: an outer ring serving as an outer member having the shape of a bottomed tube and having three raceway grooves formed in its inner peripheral surface so as to extend in the direction of a central axis of the outer ring; a tripod member serving as an inner member having three tripod shaft portions that are inserted in the raceway grooves of the outer ring; and a plurality of rolling elements interposed between the outer peripheral surface of each tripod shaft portion and the inner surface of a corresponding one of the raceway grooves (see Japanese Patent Application Publication Nos. 2010-7701 (JP 2010-7701 A) and H10-9248 (JP H10-9248 A)).

The sliding CV joint described in JP 2010-7701 A includes roller units each having a plurality of rolling elements. Each of the roller units is placed between the tripod shaft portion and the inner surface of the raceway groove. The roller unit includes an intermediate member, a plurality of rolling elements, and a cage. The intermediate member is formed by a pair of divided members placed so as to be separated from each other with the tripod shaft portion interposed therebetween, and is placed so as to be swingable relative to the tripod shaft portion. The plurality of rolling elements are rollably placed between the inner surface of the raceway surface and a power transmission surface of the intermediate member. Each of the rolling elements is formed by a columnar body and a pair of needle-like projections standing on both axial end faces of the body. The cage holds the plurality of rolling elements so that the plurality of rolling elements can move on the outer periphery of the intermediate member in a circulating manner. The cage is formed by a pair of circulation path forming members. The pair of circulation path forming members that are coupled to face each other so as to hold both axial ends of the plurality of rolling elements. Each of the pair of circulation path forming members has a groove that guides the needle-like projections of the rolling elements. The groove is formed so as to extend along a circulation path for the rolling elements.

This sliding CV joint together with an intermediate shaft fitted in the tripod member forms a drive shaft and is mounted on a vehicle as shown in, e.g., FIGS. 1 and 2 of JP H10-9248 A. That is, a shaft-like stem of the outer ring is inserted into an insertion hole formed in the center of a side gear of a differential unit, and is coupled to the side gear by, e.g., spline fitting so as not to be rotatable relative to the side gear. The stem of the outer ring has in its tip end an annular groove in which a retainer is fitted. The retainer in the shape of a ring such as a snap ring prevents the stem from coming off from the side gear.

When the sliding CV joint described in JP 2010-7701 A is mounted on a vehicle, the roller units are sometimes pressed against a bottom portion of the outer ring. That is, when the operator holds the shaft coupled to the tripod member and inserts the stem of the outer ring into the insertion hole of the side gear from the outside of a differential case with the retainer being fitted in the annular groove of the stem, the roller units are pressed against the bottom portion of the outer ring via the tripod member and the intermediate member and are subjected to a pressing force. When passing through the insertion hole in the side gear, the retainer elastically contracts and is contained in the annular groove. After passing through the insertion hole, the retainer is restored to its original size, so that an outer peripheral portion of the retainer protrudes from the annular groove. The retainer thus prevents the stem from coming off from the side gear.

For example, if the operator strongly presses the shaft when mounting the sliding CV joint on the vehicle, each tripod shaft portion of the tripod member strongly presses the pair of divided members in such a direction that the pair of divided members are separated from each other. The rolling elements are therefore pressed toward raceway surfaces by the pair of divided members, and the needle-like projections of the rolling elements contact the outer side surfaces in the grooves of the cage. The pressing force is thus transmitted to the cage. The cage may be deformed by the pressing force, which may hinder smooth rolling of the rolling elements. Accordingly, the strength of the cage need be ensured by, e.g., increasing the thickness of the pair of circulation path forming members. This affects reduction in size and weight and reduction in cost of the sliding CV joint.

### SUMMARY OF THE INVENTION

It is one object of the present invention to provide a sliding CV joint that can restrain a pressing force from being transmitted to a cage when an inner member is pressed toward a bottom portion of an outer member at the time the sliding CV joint is mounted on a vehicle.

According to one aspect of the present invention, a sliding CV joint includes: an outer member having a tube portion that has a plurality of raceway grooves each having a pair of raceway surfaces extending in a direction of a central axis and facing each other, and a bottom portion that closes one end of the tube portion; an inner member having an annular boss portion that is coupled to a shaft, and a plurality of leg shafts that stand so as to extend outward in a radial direction of the boss portion from an outer peripheral surface of the boss portion and that are each inserted in corresponding one of the plurality of raceway grooves; a pair of intermediate members placed so as to be separated from each other with the leg shaft interposed therebetween; a plurality of rolling elements placed between the pair of raceway surfaces and outer surfaces of the pair of intermediate members; and a cage that holds the plurality of rolling elements so that the plurality of rolling elements can roll on the outer surfaces of the intermediate members. The rolling elements each have a columnar body and a pair of needle-like projections standing on both axial end faces of the body. The cage has a groove that guides the pair of needle-like projections. When the inner member is moved toward the bottom portion in the outer member and the pair of intermediate members are subjected to a pressing force from the leg shaft in such a direction that the pair of intermediate members are separated from each other so that the rolling elements are pressed by the pair of intermediate members and the bodies of the rolling elements are brought into contact with the pair of raceway surfaces, there is predetermined clearance between a side surface in the groove and outer peripheral surfaces of the needle-like projections of the rolling elements.

According to the present invention, the pressing force can be restrained from being transmitted to the cage when the inner member is pressed toward the bottom portion of the outer member at the time the sliding CV joint is mounted on a vehicle.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a partial cutaway view showing an entire sliding CV joint according to an embodiment of the present invention;

FIG. 2 is a plan view of an outer ring of the sliding CV joint as viewed in the direction of a rotation axis of the outer ring;

FIG. 3 is an exploded perspective view showing a tripod member and a roller unit;

FIG. 4 is a front view of the roller unit;

FIG. 5A is a sectional view taken along a line A-A in FIG. 4;

FIG. 5B is a sectional view taken along a line B-B in FIG. 4;

FIG. 6 schematically shows rolling elements, a cage, and a tripod shaft portion of the tripod member which are placed between a pair of raceway surfaces of the outer ring, where the upper half of FIG. 6 shows a front view as viewed in the same direction as that of the B-B sectional view of FIG. 4, and the lower half of FIG. 6 shows a plan view;

FIG. 7 schematically shows the state of the rolling elements, the cage, and the tripod shaft portion of the tripod member at the time a head of the tripod member has moved in the direction of a central axis from the state shown in FIG. 6, where the upper half of FIG. 7 shows a front view, and the lower half of FIG. 7 shows a plan view; and

FIG. 8 schematically shows rolling elements, a cage, and a tripod shaft portion of a tripod member of a CV joint of a comparative example which are in the same state as that in FIG. 7, where the upper half of FIG. 8 shows a front view, and the lower half of FIG. 8 shows a plan view.

### DETAILED DESCRIPTION OF EMBODIMENTS

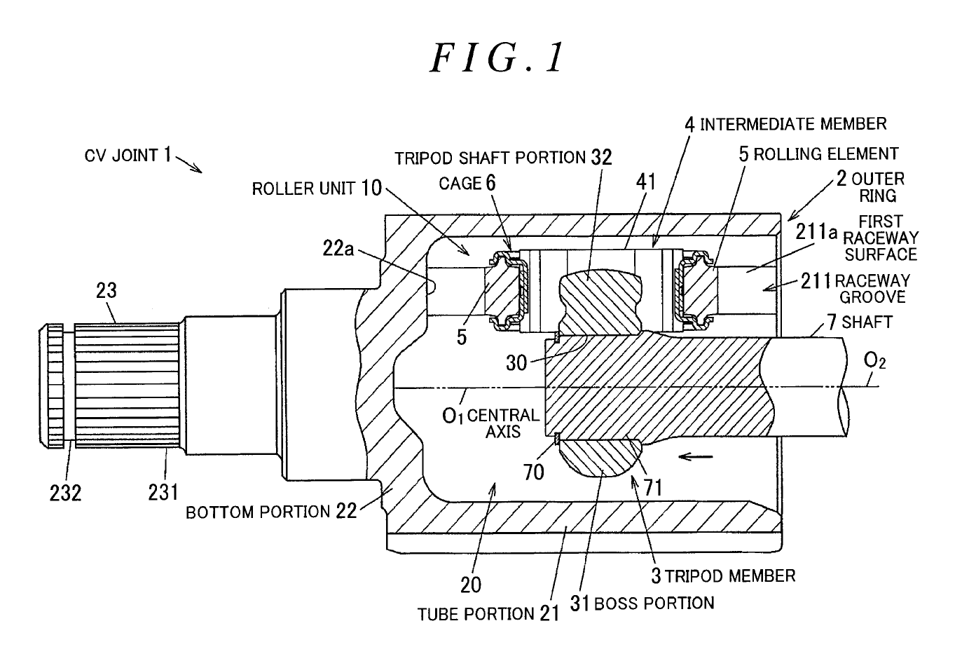

A sliding constant velocity (CV) joint according to an embodiment of the present invention will be described below with reference to FIGS. 1 to 7.

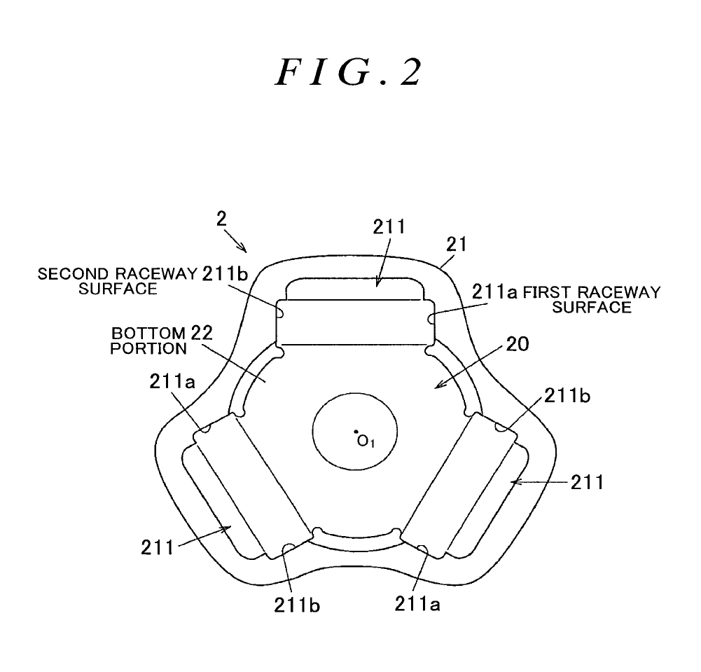

FIG. 1 is a partial cutaway view showing the entire sliding CV joint according to the embodiment. FIG. 2 is a plan view of an outer ring of the sliding CV joint as viewed in the direction of a rotation axis O₁ of the outer ring. Hereinafter, the sliding CV joint will be simply referred to as the “CV joint.”

A CV joint 1 is placed between a side gear, not shown, serving as an output member of a differential unit of a vehicle and a shaft (intermediate shaft of a drive shaft) 7 to transmit a driving force for rotating wheels to the shaft 7. The CV joint 1 is also called a “tripod CV joint” and includes an outer ring 2 serving as an outer member, a tripod member 3 serving as an inner member, and three roller units 10 (only one roller unit 10 is shown in FIG. 1). The outer ring 2 is coupled to the side gear of the differential unit so as to rotate together therewith. The tripod member 3 is coupled to the shaft 7 so as to rotate together therewith. The roller units 10 are fitted on tripod shaft portions 32 serving as leg shafts of the tripod member 3 described below. The configuration of these members etc. will be described in detail below.

The outer ring 2 has a tube portion 21, a bottom portion 22, and a stem portion 23. The tube portion 21 has a plurality of (three) raceway grooves 211 extending in the direction of a central axis. The bottom portion 22 closes one end of the tube portion 21. The stem portion 23 is in the shape of a shaft and projects from the center of the bottom portion 22 to the opposite side from the tube portion 21. The tube portion 21 and the bottom portion 22 together form the shape of a bottomed tube, and the tube portion 21 has an accommodating space 20 formed therein to accommodate the tripod member 3 and the three roller units 10. The central axis of the tube portion 21 coincides with the rotation axis O₁ of the outer ring 2. FIG. 1 shows the state where a joint angle is zero, namely the state where the rotation axis O₁ of the outer ring 2 coincides with a rotation axis O₂ of the shaft 7. Hereinafter, a direction parallel to the central axis of the tube portion 21 (the rotation axis O₁ of the outer ring 2) will be referred to as the “direction of the central axis of the outer ring 2.”

As shown in FIG. 2, the three raceway grooves 211 are formed at regular intervals in the circumferential direction of the tube portion 21 so as to be recessed outward from the center of the tube portion 21. The three roller units 10 are accommodated in the three raceway grooves 211. The inner surface of each raceway groove 211 includes a pair of raceway surfaces 211a, 211b extending in the direction of the central axis of the outer ring 2 and facing each other. The pair of raceway surfaces 211a, 211b are flat surfaces and face each other so as to be parallel to each other. In the following description, the terms “first raceway surface 211a” and “second raceway surface 211b” are used when there is a need to distinguish the pair of raceway surfaces 211a, 211b from each other. The first raceway surface 211a refers to the raceway surface on which a plurality of rolling elements 5, described below, of the roller unit 10 roll when the vehicle is accelerated to move forward, and the second raceway surface 211b refers to the other raceway surface.

The bottom portion 22 has a flat bottom surface 22a extending perpendicularly to the direction in which the raceway grooves 211 extend. The rolling elements 5 of the roller units 10 are brought into contact with the bottom surface 22a when the tripod member 3 moves toward the bottom of the accommodating space 20 of the tube portion 21.

The stem portion 23 has a spline fitting portion 231 that is spline-fitted on the side gear of the differential unit. The stem portion 23 further has an annular groove 232 at its tip end (the end located on the opposite side from its base end located on the bottom portion 22 side). The annular groove 232 is formed at a position closer to the end face of the tip end than the spline fitting portion 231 is, and holds a ring-shaped retainer (not shown) such as a snap ring.

Each roller unit 10 includes an intermediate member 4, the plurality of rolling elements 5, and a cage 6. The intermediate member 4 is formed by a pair of divided members 41, 42 (only one divided member 41 is shown in FIG. 1). The plurality of rolling elements 5 are placed on the outer periphery of the intermediate member 4. The cage 6 holds the plurality of rolling elements 5.

The tripod member 3 is an annular member that is formed by the tripod shaft portions 32 described above and a boss portion 31 forming a body of the tripod member 3. The boss portion 31 of the tripod member 3 has an insertion hole 30 so that the shaft 7 is inserted therethrough. The shaft 7 has a spline fitting portion 71 at its end, and the boss portion 31 of the tripod member 3 is fitted on the spline fitting portion 71 of the shaft 7 so that the boss portion 31 cannot rotate relative to the spline fitting portion 71. A snap ring 70 fitted on the shaft 7 prevents the tripod member 3 from coming off from the shaft 7.

The tripod member 3 can move relative to the outer ring 2 within a predetermined moving range in the direction of the central axis of the outer ring 2. When the CV joint 1 is attached to the differential unit of the vehicle, the tripod member 3 is pressed toward the bottom portion 22 of the outer ring 2 (in the direction shown by an arrow in FIG. 1) via the shaft 7. Movement of the tripod member 3 toward the bottom portion 22 of the outer ring 2 is restricted by the rolling elements 5 of the roller units 10 abutting on the bottom surface 22a.

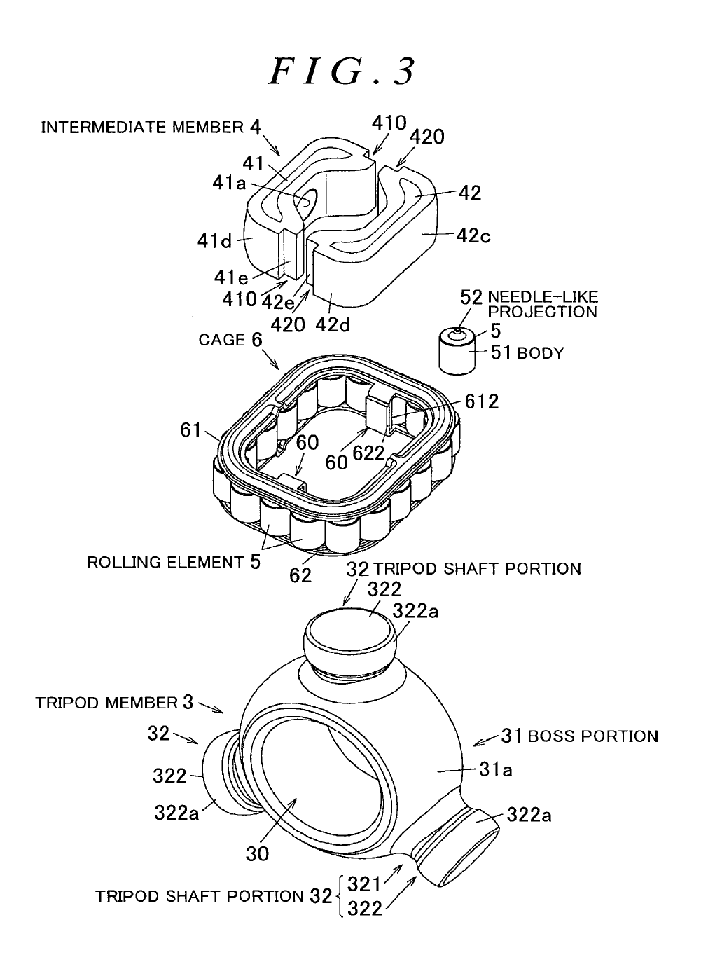

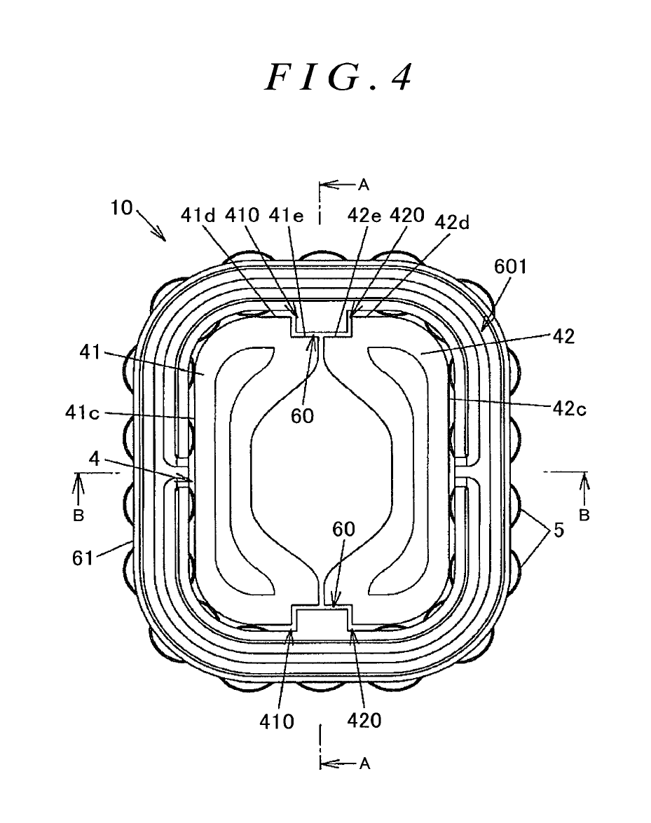

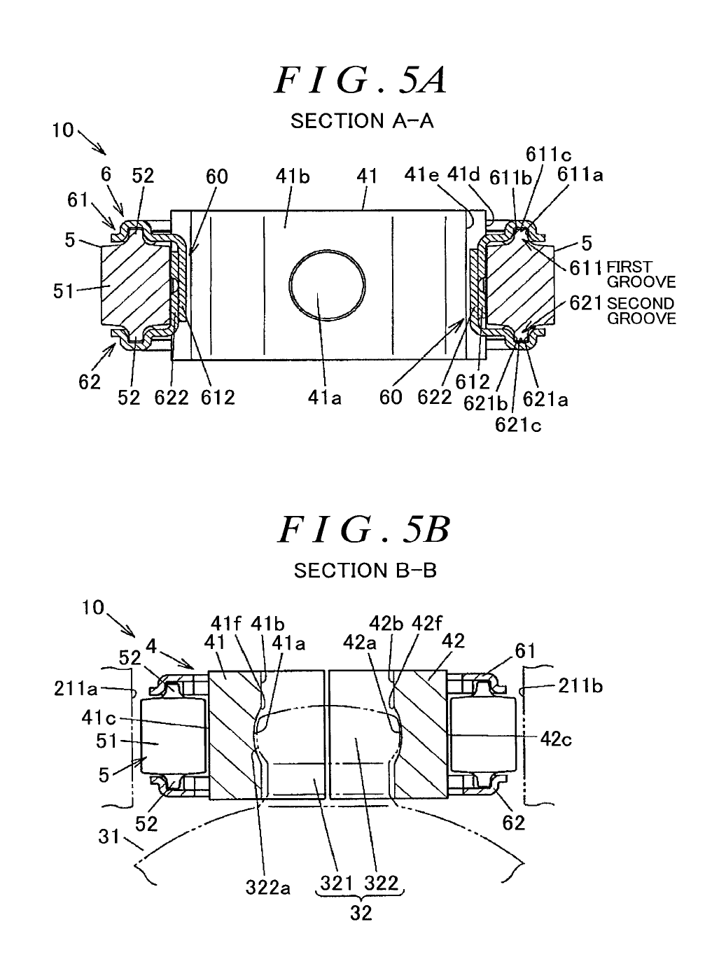

FIG. 3 is an exploded perspective view showing the tripod member 3 and the roller unit 10 to be fitted on one of the tripod shaft portions 32. FIG. 4 is a front view of the roller unit 10. FIG. 5A is a sectional view taken along line A-A in FIG. 4, and FIG. 5B is a sectional view taken along line B-B in FIG. 4. In FIG. 5B, the tripod shaft portion 32 of the tripod member 3, and the first and second raceway surfaces 211a, 211b of the raceway groove 211 of the outer ring 2 are shown by long dashed double-short dashed lines.

The roller unit 10 includes the intermediate member 4, the plurality of rolling elements 5, and the cage 6. The intermediate member 4 is formed by the pair of divided members 41, 42 placed so as to be separated from each other with a head 322 of the tripod shaft portion 32 interposed therebetween. The plurality of rolling elements 5 roll on one of the pair of raceway surfaces 211a, 211b (shown in FIG. 2) of the raceway groove 211 in accordance with the rotation direction of the outer ring 2 and the direction of torque transmission between the outer ring 2 and the shaft 7. The cage 6 holds the plurality of rolling elements 5 so that the rolling elements 5 can move on the outer periphery of the intermediate member 4 in a circulating manner.

As shown in FIG. 3, the tripod member 3 includes the annular boss portion 31 and the plurality of (three) tripod shaft portions 32. The tripod shaft portions 32 stand so as to extend outward in the radial direction of the boss portion 31 from an outer peripheral surface 31a of the boss portion 31, and are inserted in the raceway grooves 211 (shown in FIG. 2) of the outer ring 2. The inner peripheral surface of the insertion hole 30 of the boss portion 31 has a plurality of spline projections that fit in the spline fitting portion 71 (shown in FIG. 1) of the shaft 7. The spline projections are not shown in FIG. 3.

The three tripod shaft portions 32 are located at regular intervals in the circumferential direction of the boss portion 31, and the tip end of each tripod shaft portions 332 has a partial spherical surface. More specifically, each tripod shaft portion 332 has a neck 321 located on the boss portion 31 side, and the head 322 having a larger outside diameter than the neck 321 and having a spherical convex outer peripheral surface 322a. The head 322 is located on the tip end side of the tripod shaft portion 32 with respect to the neck 321. The roller units 10 are swingably fitted on the heads 322 of the three tripod shaft portions 32.

The intermediate member 4 is placed between the tripod shaft portion 32 and the plurality of rolling elements 5. One divided member 41 (hereinafter referred to as the “first divided member 41) of the intermediate member 4 is placed between the tripod shaft portion 32 and the first raceway surface 211a, and the other divided member 42 (hereinafter referred to as the “second divided member 42) of the intermediate member 4 is placed between the tripod shaft portion 32 and the second raceway surface 211b. The first divided member 41 and the second divided member 42 are shaped symmetrically with each other.

The first and second divided members 41, 42 have concave surfaces 41a, 42a, respectively (only the concave surface 41a of the first divided member 41 is shown in FIG. 3). The concave surfaces 41a, 42a are partial spherical surfaces, and the outer peripheral surface 322a of the head 322 of the tripod shaft portion 32 contacts the concave surfaces 41a, 42a. This allows the head 322 of the tripod shaft portion 32 to swing relative to the intermediate member 4.

The first and second divided members 41, 42 further have flat rolling surfaces 41c, 42c, respectively (only the rolling surface 42c of the second divided member 42 is shown in FIG. 3). The rolling surfaces 41c, 42c are the surfaces located on the opposite side of the first and second divided members 41, 42 from the concave surfaces 41a, 42a, and the plurality of rolling elements 5 roll on the rolling surfaces 41c, 42c.

The first and second divided members 41, 42 have cutouts 410, 420, respectively, in order to avoid interference with joints 60 of the cage 6 described below. Each of the end faces of the first and second divided members 41, 42 in the direction of the central axis of the outer ring 2 is formed by a first end face 41d, 42d that is formed in a portion where the cutout 410, 420 is not formed, and a second end face 41e, 42e that is formed in the cutout 410, 420.

Each rolling element 5 has the shape of a shaft and includes a columnar body 51 and a pair of needle-like projections 52 standing on both axial end faces of the body 51. In the present embodiment, 18 rolling elements 5 are placed around the intermediate member 4. The number of rolling elements 5 can be changed as appropriate in accordance with the torque transmission capacity of the CV joint 1 etc. In FIG. 3, one rolling element 5 is shown outside the cage 6.

The cage 6 is formed by coupling a pair of circulation path forming members 61, 62 that sandwich the plurality of rolling elements 5 therebetween in the axial direction thereof. The cage 6 has the shape of a rectangle with rounded corners (the shape of a rounded rectangle) as viewed from the front in the radial direction of the outer ring 2 (see FIG. 4 described below). In the following description, the first circulation path forming member 61 refers to one of the pair of circulation path forming members 61, 62 which is located at a radially outer position in the accommodating space 20 of the outer ring 2, namely at a position farther from the rotation axis O₁, and the second circulation path forming member 62 refers to the other circulation path forming member. The first and second circulation path forming members 61, 62 are formed by pressing a sheet metal material.

The first and second circulation path forming members 61, 62 of the cage 6 are coupled by the pair of joints 60, 60. The pair of joints 60, 60 are located inward of (closer to the tripod shaft portion 32 than) the track of the circulating motion of the plurality of rolling elements 5 and are arranged side by side in the direction of the central axis of the tube portion 21.

Each joint 60 of the cage 6 is formed by placing a first joint piece 612 formed in the first circulation path forming member 61 and a second joint piece 622 formed in the second circulation path forming member 62 on top of each other and connecting the first and second joint pieces 612, 622. In the present embodiment, the first and second joint pieces 612, 622 are connected by caulking. However, the present invention is not limited to this. For example, the first and second joint pieces 612 622 may be connected by welding.

As shown in FIG. 4, the first end faces 41d of the first divided member 41 are in contact with the bodies 51 of the rolling elements 5, and the second end faces 41e of the first divided member 41 face the joints 60 of the cage 6 with clearance therebetween. For example, when the CV joint 1 is attached to the differential unit, the tripod member 3 is pressed toward the bottom portion 22 of the outer ring 2 and the bodies 51 of the rolling elements 5 are brought into contact with the bottom surface 22a. At this time, the first end faces 41d, 42d of the first and second divided members 41, 42 contact the bodies 51 of the rolling elements 5, whereas there is clearance between each joint 60 of the cage 6 and the second end faces 41e, 42e, so that the pressing force in the direction of the central axis is not transmitted to the cage 6.

As shown in FIG. 5A, the first circulation path forming member 61 has a first groove 611 that guides the first needle-like projection 52 of the pair of needle-like projections 52 of each rolling element 5. The second circulation path forming member 62 has a second groove 621 that guides the second needle-like projection 52 of the pair of needle-like projections 52 of each rolling element 5. The first groove 611 has a U-shape and is recessed so that its bottom is located away from the second circulation path forming member 62. The second groove 621 has a U-shape and is recessed so that its bottom is located away from the first circulation path forming member 61.

The inner surface of the first groove 611 is formed by an outer side surface 611a, an inner side surface 611b, and a bottom surface 611c. The outer side surface 611a and the inner side surface 611b face each other with the first needle-like projections 52 of the rolling elements 5 interposed therebetween, and the bottom surface 611c serves as the bottom of the first groove 611. The needle-like projections 52 in the first groove 611, namely the first needle-like projections 52, are thus placed between the outer side surface 611a and the inner side surface 611b. The inner side surface 611b is formed on the joint 60 side of the first groove 611, and the outer side surface 611a is formed on the opposite side of the first groove 611 from the joint 60 side.

Similarly, the inner surface of the second groove 621 is formed by an outer side surface 621a, an inner side surface 621b, and a bottom surface 621c. The outer side surface 621a and the inner side surface 621b face each other with the second needle-like projections 52 of the rolling elements 5 interposed therebetween, and the bottom surface 621c serves as the bottom of the second groove 621. The needle-like projections 52 in the second groove 621, namely the second needle-like projections 52, are thus placed between the outer side surface 621a and the inner side surface 621b. The inner side surface 621b is formed on the joint 60 side of the second groove 621, and the outer side surface 621a is formed on the opposite side of the second groove 621 from the joint 60 side.

As shown in FIG. 5B, the first divided member 41 and the second divided member 42 have the concave surfaces 41a, 42a described above, respectively. The first divided member 41 and the second divided member 42 further have flat surfaces 41b, 42b that are formed around the concave surfaces 41a, 42a, respectively. The flat surfaces 41b, 42b of the first and second divided members 41, 42 face each other with the head 322 of the tripod shaft portion 32 interposed therebetween. The concave surface 41a of the first divided member 41 is recessed toward the first raceway surface 211a, and the concave surface 42a of the second divided member 42 is recessed toward the second raceway surface 211b.

With the head 322 of the tripod shaft portion 32 of the tripod member 3 being located at an intermediate position in the direction of the central axis of the tripod shaft portion 32 (the vertical direction in FIG. 5B) within the concave surfaces 41a, 42a of the first and second divided members 41, 42, the outer peripheral surface 322a of the tripod shaft portion 32 does not contact edges 41f, 42f of the first and second divided members 41, 42. The edge 41f is formed at the boundary between the flat surface 41b and the concave surface 41a of the first divided member 41, and the edge 42f is formed at the boundary between the flat surface 42b and the concave surface 42a of the second divided member 42.

The rolling surface 41c of the first divided member 41 faces the first raceway surface 211a of the outer ring 2 with the rolling elements 5 interposed therebetween, and the rolling surface 42c of the second divided member 42 faces the second raceway surface 211b of the outer ring 2 with the rolling elements 5 interposed therebetween.

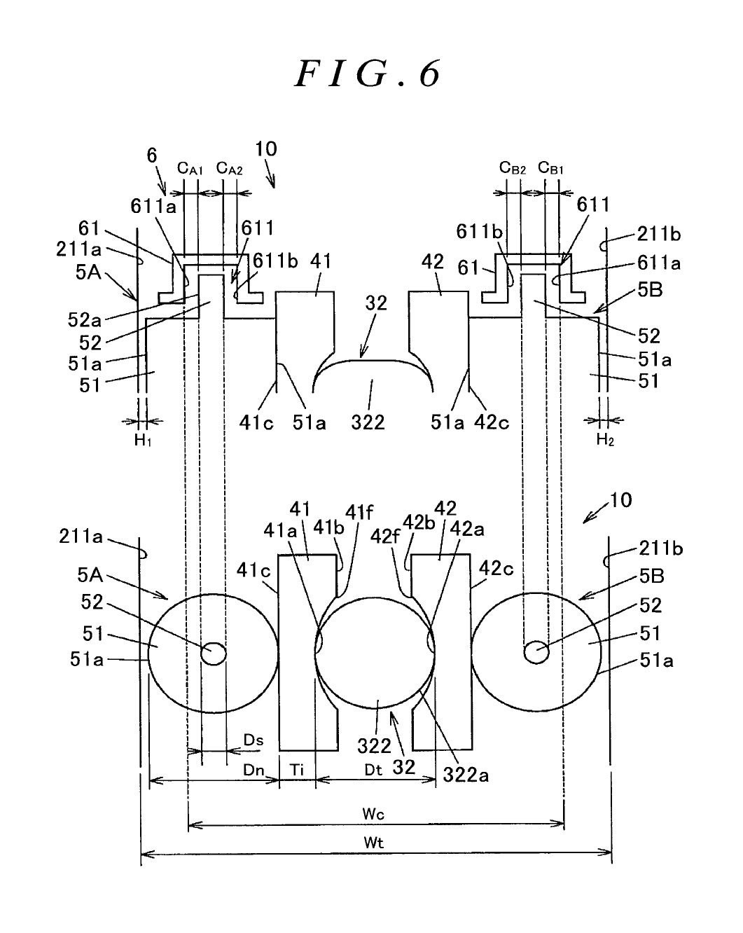

The dimensions of each part of the outer ring 2, the tripod member 3, and the roller units 10 of the CV joint 1 of the present embodiment will be described below with reference to FIG. 6. FIG. 6 schematically shows the rolling elements 5, the cage 6, the first and second divided members 41, 42, and the tripod shaft portion 32 of the tripod member 3 which are placed between the first and second raceway surfaces 211a, 211b of the outer ring 2. The upper half of FIG. 6 shows a front view, and the lower half of FIG. 6 shows a top view.

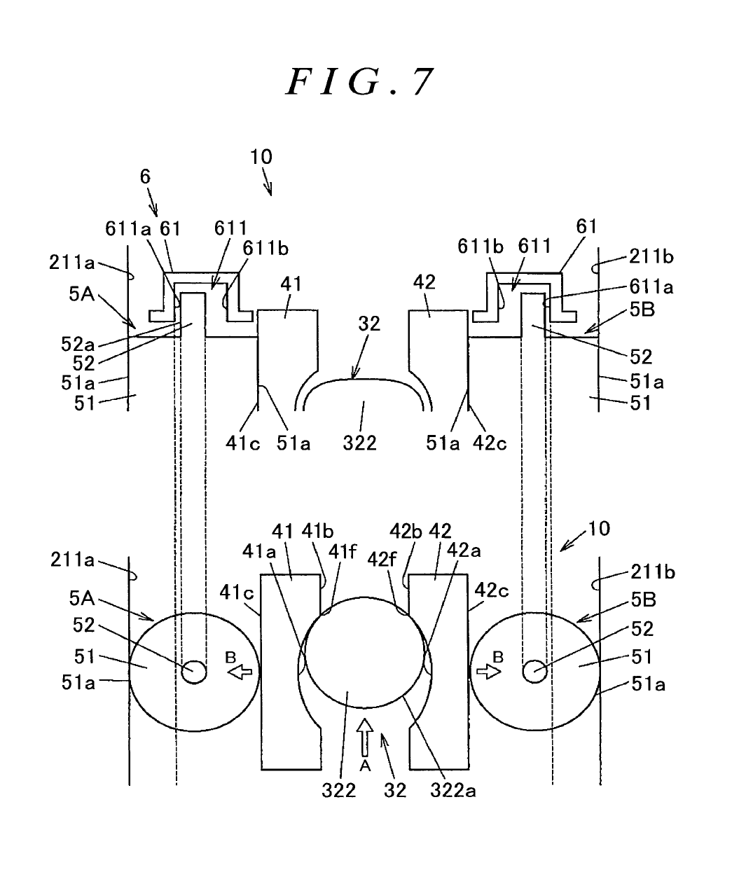

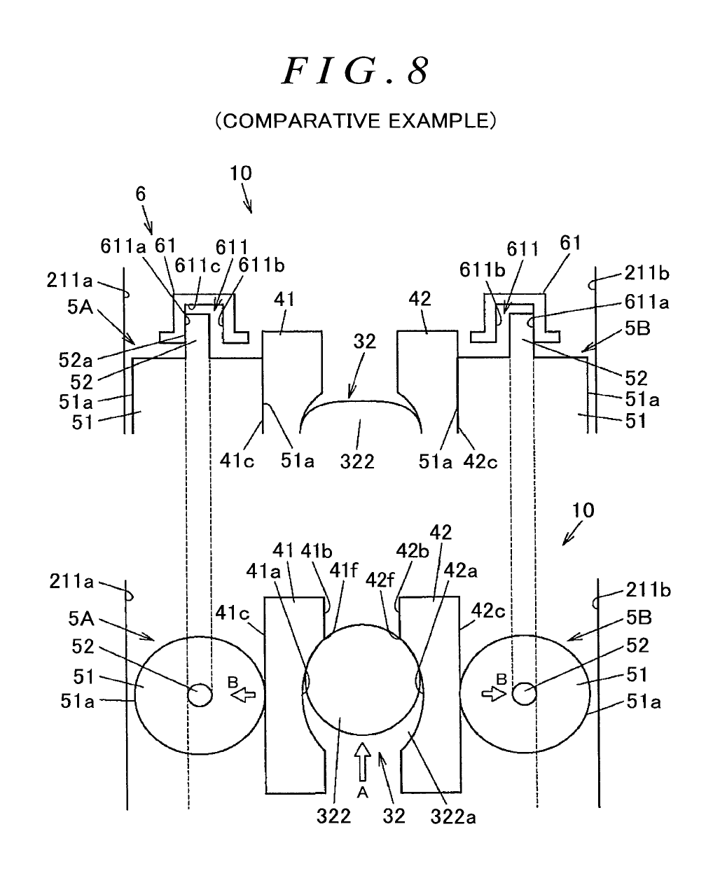

For clarity of description, in FIG. 6, the first rolling element 5A refers to the rolling element 5 that rolls on the first raceway surface 211a, and the second rolling element 5B refers to the rolling element 5 that rolls on the second raceway surface 211b. The second groove 621 of the second circulation path forming member 62 of the cage 6 and the needle-like projections 52 of the first and second rolling elements 5A, 5B which engage with the second groove 621 are not shown in FIG. 6, because their configurations and positional relationship are similar to those of the first groove 611 of the first circulation path forming member 61 and the needle-like projections 52 of the first and second rolling elements 5A, 5B which engage with the first groove 611. The same applies to FIGS. 7 and 8 described below.

In the state shown in FIG. 6, an outer peripheral surface 52a of the needle-like projection 52 of the first rolling element 5A faces the outer side surface 611a and the inner side surface 611b of the first groove 611 with clearance therebetween. The needle-like projection 52 of the first rolling element 5A is located in the middle between the outer side surface 611a and the inner side surface 611b in the first groove 611.

Namely, clearance C_{A1} between the outer peripheral surface 52a of the needle-like projection 52 of the first rolling element 5A and the outer side surface 611a of the first groove 611 is equal to clearance C_{A2} between the outer peripheral surface 52a of the needle-like projection 52 of the first rolling element 5A and the inner side surface 611b of the first groove 611. Similarly, clearance C_{B1} between the outer peripheral surface 52a of the needle-like projection 52 of the second rolling element 5B and the outer side surface 611a of the first groove 611 is equal to clearance C_{B2} between the outer peripheral surface 52a of the needle-like projection 52 of the second rolling element 5B and the inner side surface 611b of the first groove 611. For example, the total clearance (C_{A1}+C_{A2}) between the outer peripheral surface 52a of the needle-like projection 52 and the outer and inner side surfaces 611a, 611b of the first groove 611 is 0.05 mm to 0.25 mm.

The rolling surface 41c of the first divided member 41 is in contact with an outer peripheral surface 51a of the body 51 of the first rolling element 5A. On the opposite side of the first rolling element 5A from the rolling surface 41c of the first divided member 41, the outer peripheral surface 51a of the body 51 of the first rolling element 5A faces the first raceway surface 211a with small clearance H₁ therebetween.

Similarly, the rolling surface 42c of the second divided member 42 is in contact with the outer peripheral surface 51a of the body 51 of the second rolling element 5B. On the opposite side of the second rolling element 5B from the rolling surface 42c of the second divided member 42, the outer peripheral surface 51a of the body 51 of the second rolling element 5B faces the second raceway surface 211b with small clearance H₂ therebetween. In the state shown in FIG. 6, the roller unit 10 is located in the middle between the first and second raceway surfaces 211a, 211b, and the clearance H₁ is equal to the clearance H₂.

As shown in the lower half of FIG. 6, the tripod shaft portion 32 of the tripod member 3 is located on the central parts of the concave surfaces 41a, 42a of the first and second divided members 41, 42, and the outer peripheral surface 322a of the head 322 contacts the deepest parts (parts having the greatest depth in a direction perpendicular to the flat surfaces 41b, 42b) of the concave surfaces 41a, 42a. In the present embodiment, the concave surfaces 41a, 42a are concave spherical surfaces having a radius of curvature slightly larger than that of the outer peripheral surface 322a of the head 322 of the tripod shaft portion 32.

In the present embodiment, the dimensions of the constituent members of the roller units 10, the tripod member 3, and the outer ring 2 are set so that the clearance H₁ between the outer peripheral surface 51a of the body 51 of the first rolling element 5A and the first raceway surface 211a is smaller than the clearance C_{A1} between the outer peripheral surface 52a of the needle-like projection 52 of the first rolling element 5A and the outer side surface 611a of the first groove 611 and the clearance H₂ between the outer peripheral surface 51a of the body 51 of the second rolling element 5B and the second raceway surface 211b is smaller than the clearance C_{B1} between the outer peripheral surface 52a of the needle-like projection 52 of the second rolling element 5B and the outer side surface 611a of the first groove 611.

More specifically, the dimensions are set to satisfy the following Inequalities (1), (2).

Wc>Wt−(Dn−Ds) (1)

Wt>Dt+2×Ti+2×Dn (2)

where Wt represents the distance between the first and second raceway surfaces 211a, 211b, Wc represents the distance between the outer side surface 611a of the first groove 611 with which the first rolling element 5A is engaged and the outer side surface 611a of the first groove 611 with which the second rolling element 5B is engaged, Dn represents the outside diameter of the body 51 of the first rolling element 5A, Ds represents the outside diameter of the needle-like projection 52, Dt represents the spherical diameter of the head 322 of the tripod shaft portion 32 (the outside diameter of the head 322 of the tripod shaft portion 32 where the outer peripheral surface 322a of the head 322 of the tripod shaft portion 32 in FIG. 5B is located closest to the first and second raceway surfaces 211a, 211b), and Ti represents the thickness of the first and second divided members 41, 42 in the deepest parts of the concave surfaces 41a, 42a.

Regarding the outside diameter Dn of the body 51 of the first rolling element 5A and the outside diameter Ds of the needle-like projection 52 in Inequalities (1), (2), the same applies to the second rolling element 5B.

Setting the dimensions of the CV joint 1 so as to satisfy Inequality (1) prevents the needle-like projections 52 of the first and second rolling elements 5A, 5B from contacting the outer side surface 611a of the first groove 611 when the first and second rolling elements 5A, 5B are pressed by the first and second divided members 41, 42 and brought into contact with the first and second raceway surfaces 211a, 211b at the time the roller unit 10 is attached as described below with reference to FIG. 7. For example, the values of the dimensions in Inequality (1) are as follows. Wt: 46.86 mm, Wc: 41.2 mm, Dn: 6.99 mm, and Ds: 1.33 mm.

Setting the dimensions of the CV joint 1 so as to satisfy Inequality (2) allows the clearance H₁, H₂ to be provided between the first rolling element 5A and the first raceway surface 211a of the outer ring 2 and between the second rolling element 5B and the second raceway surface 211b of the outer ring 2 when the first and second rolling elements 5A, 5B are pressed by the first and second divided members 41, 42 at the time the roller unit 10 is attached, whereby the roller unit 10 can be smoothly moved in the tube portion 21 of the outer ring 2. For example, the values of the dimensions in Inequality (2) are as follows. Wt: 46.64 mm, Dt: 24.64 mm, Dn: 7.0 mm, and Ti: 4.0 mm.

Regarding the CV joint 1 having the configuration described with respect to FIGS. 1 to 6, when the roller unit 10 is pressed against the bottom portion 22 of the outer ring 2 how the rolling elements 5, the cage 6, and the tripod member 3 operate will be described with reference to FIG. 7.

FIG. 7 schematically shows the state of the rolling elements 5, the cage 6, and the tripod shaft portion 32 of the tripod member 3 at the time the head 322 of the tripod member 3 has moved in the direction of the central axis from the state shown in FIG. 6. The upper half of FIG. 7 shows a front view, and the lower half of FIG. 7 shows a plan view.

When the tripod member 3 is pressed toward the bottom portion 22 of the outer ring 2 and the rolling elements 5 are brought into contact with the bottom portion 22, movement of the first and second divided members 41, 42 in the direction of the central axis (a direction parallel to the first and second raceway surfaces 211a, 211b) is restricted. FIG. 7 shows the state where the movement of the first and second divided members 41, 42 in the direction of the central axis is restricted.

As shown in FIG. 7, when the tripod member 3 is pressed toward the bottom portion 22 of the outer ring 2, the head 322 of the tripod shaft portion 32 of the tripod member 3 moves on the concave surfaces 41a, 42a in a direction perpendicular to the direction in which the first and second divided members 41, 42 are arranged (in the direction shown by an arrow A in FIG. 7), so that the outer peripheral surface 322a of the head 322 contacts the edges 41f, 42f of the first and second divided members 41, 42.

At this time, the first and second divided members 41, 42 are subjected at the edges 41f, 42f to a pressing force in a direction tilted with respect to the direction in which the head 322 moves. The first and second divided members 41, 42 are therefore subjected to a force in a direction in which the first and second divided members 41, 42 are separated from each other (the direction shown by arrows B in FIG. 7) due to a component in the horizontal direction (the direction perpendicular to the direction in which the head 322 moves) of the pressing force.

Accordingly, the first rolling element 5A is pressed toward the first raceway surface 211a by the first divided member 41, and the outer peripheral surface 51a of the body 51 of the first rolling element 5A is brought into contact with the first raceway surface 211a. The second rolling element 5B is pressed toward the second raceway surface 211b by the second divided member 42, and the outer peripheral surface 51a of the body 51 of the second rolling element 5B is brought into contact with the second raceway surface 211b.

At this time, as the first rolling element 5A moves toward the first raceway surface 211a, the needle-like projection 52 moves toward the outer side surface 611a of the first groove 611 and the clearance C_{A1} decreases accordingly. That is, when the first rolling element 5A contacts the first raceway surface 211a, there is predetermined clearance, which is smaller than the clearance C_{A1}, between the outer peripheral surface 52a of the needle-like projection 52 of the first rolling element 5A and the outer side surface 611a of the first groove 611 of the cage 6. This prevents the pressing force that is applied by the head 322 of the tripod shaft portion 32 of the tripod member 3 in the direction in which the first and second divided members 41, 42 are separated from each other from being transmitted to the cage 6 via the needle-like projections 52 of the first and second rolling elements 5A, 5B.

A CV joint according to a comparative example will be described below with reference to FIG. 8. FIG. 8 schematically shows the rolling elements 5, the cage 6, and the tripod shaft portion 32 of the tripod member 3 in the roller unit 10 of the comparative example, which are in the same state as that in FIG. 7. The upper half of FIG. 8 shows a front view, and the lower half of FIG. 8 shows a plan view.

The CV joint of the comparative example shown in FIG. 8 is different from that of the embodiment in the dimensions of each part described above with reference to FIG. 6. The CV joint of the comparative example is otherwise similar to that of the embodiment. In FIG. 8, those members having the same function as that described in the embodiment shown in FIG. 7 are denoted with the same reference characters as those in FIG. 7, and description thereof will be omitted.

In the CV joint 1 of the comparative example, the dimensions of each constituent member of the roller unit 10, the tripod member 3, and the outer ring 2 are set so that the clearance H₁ between the outer peripheral surface 51a of the body 51 of the first rolling element 5A and the first raceway surface 211a shown in the upper half of FIG. 6 is larger than the clearance C_{A1} between the outer peripheral surface 52a of the needle-like projection 52 of the first rolling element 5A and the outer side surface 611a of the first groove 611, and the clearance H₂ between the outer peripheral surface 51a of the body 51 of the second rolling element 5B and the second raceway surface 211b is larger than the clearance C_{B1} between the outer peripheral surface 52a of the needle-like projection 52 of the second rolling element 5B and the outer side surface 611a of the first groove 611. That is, the dimensions of the CV joint 1 of the comparative example do not satisfy Inequality (1) described in the embodiment.

In the roller unit 10 of the comparative example configured as described above, the outer peripheral surfaces 52a of the needle-like projections 52 of the first and second rolling elements 5A, 5B contact the outer side surface 611a of the first groove 611 of the cage 6 before the outer peripheral surfaces 51a of the bodies 51 of the first and second rolling elements 5A, 5B contact the first and second raceway surfaces 211a, 211b. The pressing force that is applied by the head 322 of the tripod shaft portion 32 of the tripod member 3 is therefore transmitted to the cage 6 via the needle-like projections 52 of the rolling elements 5. Accordingly, in the comparative example in which the dimensions do not satisfy Inequality (1), the cage 6 may be deformed by the pressing force that is applied by the tripod member 3 when the CV joint 1 is assembled. However, the present embodiment can restrain deformation of the cage 6 because the pressing force of the tripod member 3 is not transmitted to the cage 6.

The above embodiment has the following functions and effects.

(1) When the CV joint 1 is assembled, the tripod member 3 is pressed toward the bottom portion 22 of the outer ring 2. When the bodies 51 of the plurality of rolling elements 5 are brought into contact with the first and second raceway surfaces 211a, 211b, there is predetermined clearance between the outer peripheral surface 52a of the needle-like projection 52 of each rolling element 5 and the outer side surfaces 611a, 621a of the first and second grooves 611, 621. This can prevent the above pressing force from being transmitted to the cage 6 via the rolling elements 5, namely can restrain deformation of the cage 6 due to the pressing force that is applied when the CV joint 1 is assembled.

(2) Since the dimensions of the CV joint 1 are set so as to satisfy Inequality (2), there is clearance between the roller unit 10 and the first and second raceway surfaces 211a, 211b of the outer ring 2, which allows the tripod member 3 to smoothly slide toward the bottom portion 22 of the outer ring 2 at the time the CV joint 1 is assembled. That is, the configuration of the above embodiment can achieve reduction in work burden imposed when the CV joint 1 is assembled, in addition to providing the effect described in (1).

(3) The first and second divided members 41, 42 have the concave surfaces 41a, 42a that contact the spherical convex outer peripheral surface 322a of the tripod shaft portion 32 of the tripod member 3. The first and second divided members 41, 42 are therefore in spherical surface contact with the tripod member 3. This configuration can increase the contact surface area as compared to the case where, e.g., the first and second divided members 41, 42 are in flat surface contact with the tripod member 3. This can reduce the load per unit area which is applied from the tripod member 3 to the first and second divided members 41, 42, and thus can increase the life of the roller unit 10.

The present invention can be modified as appropriate without departing from the spirit and scope of the invention. For example, the above embodiment is described with respect to the case where the cage 6 has a rounded rectangular shape. However, the present invention is not limited to this. For example, the cage 6 may have the shape of a track having a semicircular shape at its both ends in the direction in which the raceway groove 211 extends.

What is claimed is:

1. A sliding constant velocity joint, comprising:
an outer member having a tube portion that has a plurality of raceway grooves each having a pair of raceway surfaces extending in a direction of a central axis and facing each other, and a bottom portion that closes one end of the tube portion;
an inner member having an annular boss portion that is coupled to a shaft, and a plurality of leg shafts that stand so as to extend outward in a radial direction of the boss portion from an outer peripheral surface of the boss portion and that are each inserted in corresponding one of the plurality of raceway grooves;
a pair of intermediate members placed so as to be separated from each other with the leg shaft interposed therebetween;
a plurality of rolling elements placed between the pair of raceway surfaces and outer surfaces of the pair of intermediate members; and
a cage that holds the plurality of rolling elements so that the plurality of rolling elements can roll on the outer surfaces of the intermediate members, wherein
the rolling elements each have a columnar body and a pair of needle-like projections standing on both axial end faces of the body, the cage has a groove that guides the pair of needle-like projections, and
when the inner member is moved toward the bottom portion in the outer member and the pair of intermediate members are subjected to a pressing force from the leg shaft in such a direction that the pair of intermediate members are separated from each other so that the rolling elements are pressed by the pair of intermediate members and the bodies of the rolling elements are brought into contact with the pair of raceway surfaces, there is predetermined clearance between a side surface in the groove and outer peripheral surfaces of the needle-like projections of the rolling elements.

2. The sliding constant velocity joint according to claim 1, wherein
dimensions of the sliding contact velocity joint are set so as to satisfy the following inequality:
Wc>Wt−(Dn=Ds)
where Dn represents an outside diameter of the body of the rolling element, Ds is an outside diameter of each of the needle-like projections of the rolling element, Wt represents a distance between the pair of raceway surfaces of the outer member, and Wc represents a distance between an outer side surface in the groove that guides the needle-like projection of the rolling element rolling on a first raceway surface of the pair of raceway surfaces and the outer side surface in the groove that guides the needle-like projection of the rolling element rolling on a second raceway surface of the pair of raceway surfaces.

3. The sliding constant velocity joint according to claim 2, wherein
the leg shaft has a spherical outer peripheral surface, and
the dimensions of the sliding contact velocity joint are set so as to satisfy the following inequality:
Wt>Dt+Ti×2+Dn×2
where Dt represents a spherical diameter of the leg shaft, and Ti represents a thickness of a thinnest part in a portion of each of the intermediate members, the portion configured to contact the outer peripheral surface of the leg shaft.

4. The sliding constant velocity joint according to claim 3, wherein
the leg shaft has a spherical convex outer peripheral surface, and
each of the pair of intermediate members has a concave surface that contacts the outer peripheral surface of the leg shaft.
